(19) United States
(12) Patent Application Publication
(10) Pub. No.: US 2009/0138273 A1
(43) Pub. Date: May 28, 2009

(54) SYSTEMS AND METHODS FOR TRANSFORMING A BUSINESS PROCESS INTO REUSABLE SERVICES

(75) Inventor: Humie Leung, Vancouver (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/944,577

(22) Filed: Nov. 23, 2007

(51) Int. Cl. G06Q 10/00

(52) U.S. Cl. 705/1

(57) ABSTRACT

In one aspect, the invention is directed to a method for establishing a service-oriented architecture-based business system incorporating service-oriented components based on a business process. The method involves selecting groups of business process model elements for exposure as services, preferably using a graphical user interface, and generating, using automated means, at least skeleton code towards performing the services, and generating code using automated means to establish an interface between the first and second services.

### FIELD OF THE INVENTION

The invention relates to the field of moving a business entity towards a service-oriented architecture and more particularly to systems for methods for establishing a system incorporating reusable services based on a business process.

### BACKGROUND OF THE INVENTION

Several steps are involved in moving a business entity over to a service-oriented architecture. One step is the modeling of the business process, including the decomposition of the business process into a set of process elements. Another step is the establishment of a system incorporating service-oriented components based on the business process model that is developed.

The establishment of the system incorporating service-oriented components is largely a manual process, and can be prone to inconsistent execution in particular where the process is divided among multiple people.

It would be advantageous to improve the efficiency of this process.

### SUMMARY OF THE INVENTION

In one aspect, the invention is directed to a method for establishing an SOA-based business system incorporating service-oriented components based on a business process, the method comprising:

providing a business process model that relates to the business process;

selecting a first set of at least one element from the business process model for exposure as a first service;

selecting a second set of at least one element from the business process model for exposure as a second service;

generating, using automated means, at least skeleton code towards performing the first and second services; and

generating code using automated means to establish an interface between the first and second services.

In another aspect, the invention is directed to a data processing system for establishing an SOA-based business system incorporating service-oriented components based on a business process model and based on a first set of business process model elements and a second set of business process model elements selected for exposure as first and second services respectively, the data processing system comprising:

at least one processor;

a bus coupled to the at least one processor;

at least one computer usable medium coupled to the bus, wherein the at least one computer usable medium contains a set of instructions and wherein the at least one processor is adapted to carry out the set of instructions by causing the data processing system to:

generate at least skeleton code towards performing the first and second services; and

generate code to establish an interface between the first and second services.

In another aspect, the invention is directed to a computer program product comprising at least one computer usable medium including computer-usable program code for establishing an SOA-based business system incorporating service-oriented components based on a business process model and based on a first set of business process model elements and a second set of business process model elements selected for exposure as first and second services respectively, the computer program product further comprising:

computer-usable program code for generating at least skeleton code towards performing the first and second services; and

computer-usable program code for generating code to establish an interface between the first and second services.

In another aspect, the invention is directed to a method for establishing an SOA-based business system incorporating service-oriented components based on a business process, the method comprising:

providing a business process model that relates to the business process;

providing a graphical user interface configured to display the business process model and configured to provide a graphical control for the user to group together elements from the business process model;

grouping together elements from the business process model for exposure as a service, using the graphical user interface; and

generating, using automated means, at least skeleton code towards performing the service.

In another aspect, the invention is directed to a data processing system for establishing an SOA-based business system incorporating service-oriented components based on a business process, the data processing system comprising:

at least one processor;

a bus coupled to the at least one processor;

at least one computer usable medium coupled to the bus, wherein the at least one computer usable medium contains a set of instructions and wherein the at least one processor is adapted to carry out the set of instructions by causing the data processing system to:

provide a business process model that relates to the business process;

provide a graphical user interface configured to display the business process model and configured to provide a graphical control for the user to group together elements from the business process model;

receive input from a user relating to grouping together elements from the business process model for exposure as a service, using the graphical user interface; and

generate at least skeleton code towards performing the service.

In another aspect, the invention is directed to a computer program product comprising at least one computer usable medium including computer-usable program code for establishing an SOA-based business system incorporating service-oriented components based on a business process, the computer program product further comprising:

computer-usable program code for providing a business process model that relates to the business process;

computer-usable program code for providing a graphical user interface configured to display the business process model and configured to provide a graphical control for the user to group together elements from the business process model;

computer-usable program code for receiving input from a user relating to grouping together elements from the business process model for exposure as a service, using the graphical user interface; and

computer-usable program code for generating at least skeleton code towards performing the service.

### BRIEF DESCRIPTION OF THE DRAWINGS

For a better understanding of the present invention, and to show more clearly how it may be carried into effect, reference will now be made, by way of example, to the accompanying drawings in which:

FIG. 1 is a pictorial representation of a data processing system in which aspects of the present invention may be implemented;

FIG. 2 is a block diagram of a data processing system in which aspects of the present invention may be implemented;

FIG. 3 is a diagram illustrating program modules and method steps for the development of a service-oriented architecture based business system based on a business process model, in accordance with a first aspect of the invention;

FIG. 4a is a business process model of a business process;

FIG. 4b is an illustration of the development of a service model from the business process model shown in FIG. 4a, using a service modeling system, in accordance with another aspect of the invention;

FIG. 4c is a representation of a service oriented architecture-based business system relating to the business process model shown in FIG. 4a;

FIG. 5 is a business process model of another business process;

FIG. 6 is an assembly view of the business process model shown in FIG. 5;

FIG. 7 shows skeleton code for a Java class relating to a service module shown in FIG. 6;

FIG. 8 shows skeleton code for a state machine relating to a service module shown in FIG. 6;

FIG. 9 is an illustration of the program flow for the business process model shown in FIG. 6;

FIG. 10 is an illustration of the operation of an SOA code development system shown in FIG. 3;

FIG. 11 is an example of the sources and targets for transformation rules applied by the SOA code development system whose operation is shown in FIG. 10; and

FIG. 12 shows a hierarchy view of the exemplary rules identified in FIG. 11.

### DETAILED DESCRIPTION OF THE INVENTION

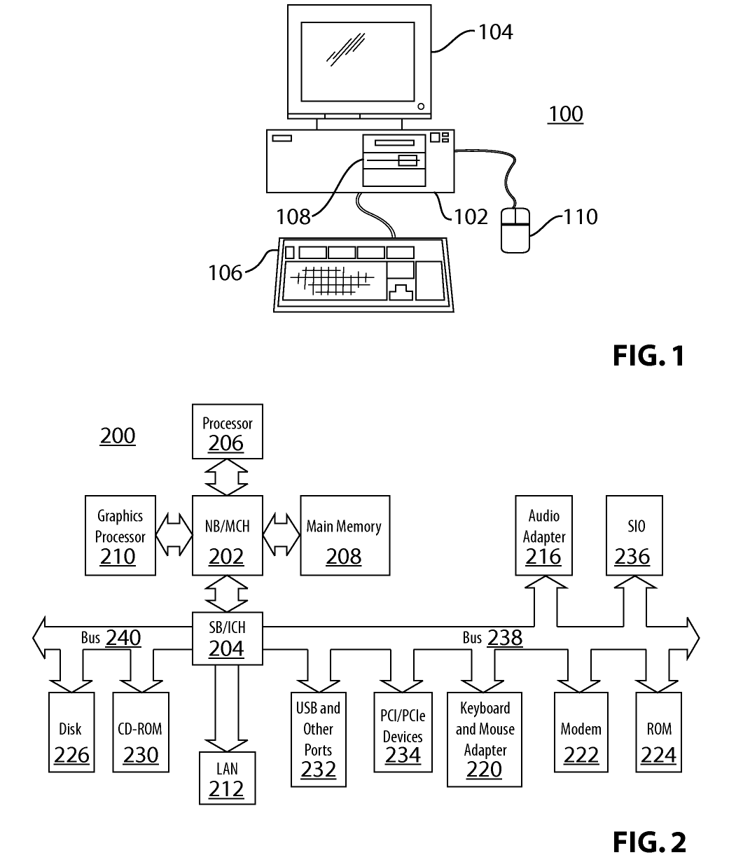

FIG. 1 is a pictorial representation of a data processing system in which aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 may be implemented using any suitable computer, such as an IBM® eServer™ computer or IntelliStation® computer, which are products of International Business Machines Corporation, located in Armonk, N.Y. Although the depicted representation shows a personal computer, exemplary aspects of the present invention may be implemented in other types of data processing systems, such as laptop computers, palmtop computers, handheld computers, network computers, servers, workstations, cellular telephones and similar wireless devices, personal digital assistants and other electronic devices on which software programs may be installed. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as personal computer 100 in FIG. 1, in which code or instructions implementing the processes of the exemplary aspects may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH 202 through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 424, universal serial bus (USB) ports and other communications ports 232, and PCI/PCIe devices 234 connect to south bridge and I/O controller hub 204 through bus 238. Hard disk drive (HDD) 226 and CD-ROM drive 230 connect to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. (Java and all Java-based trademarks are trademarks of Sun Microsystems, Inc. in the United States, other countries, or both.)

Instructions for the operating system, the object-oriented programming system, and applications or programs are located on storage devices, such as hard disk drive 226, and may be loaded into main memory 208 for execution by processor 206. Aspects of the present invention may be performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which may be configured with flash memory to provide non-volatile memory for storing operating system files and/or user-generated data. A memory may be, for example, main memory 208 or a cache such as found in north bridge and memory controller hub 202. A processing unit may include one or more processors. The depicted examples in FIGS. 1-2 and above-described examples are not meant to imply architectural limitations. For example, data processing system 200 also may be a tablet computer, laptop computer, or telephone device in addition to taking the form of a PDA.

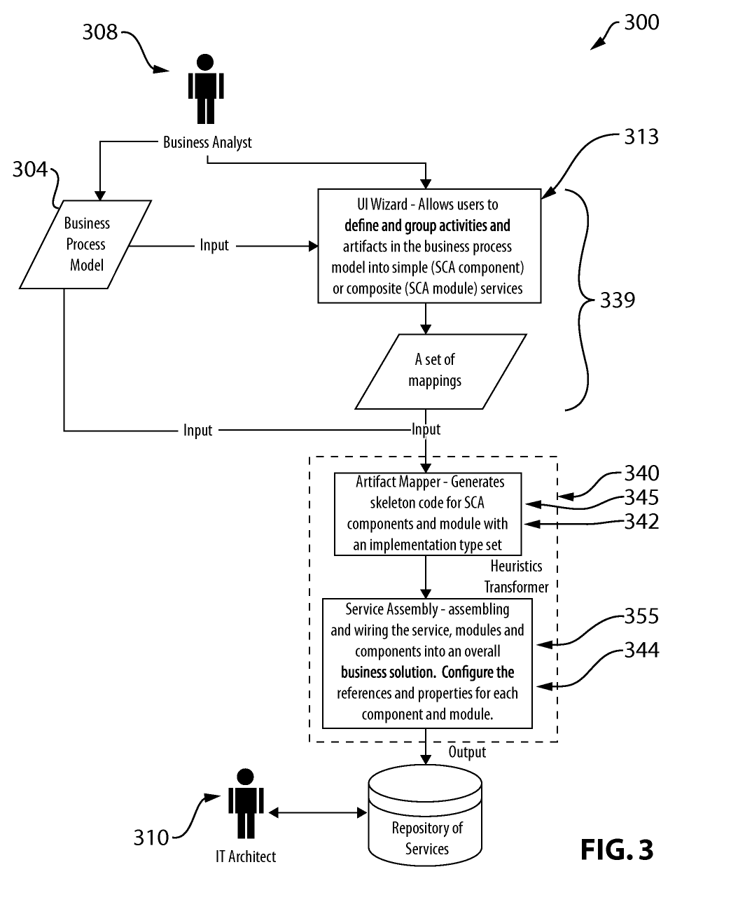

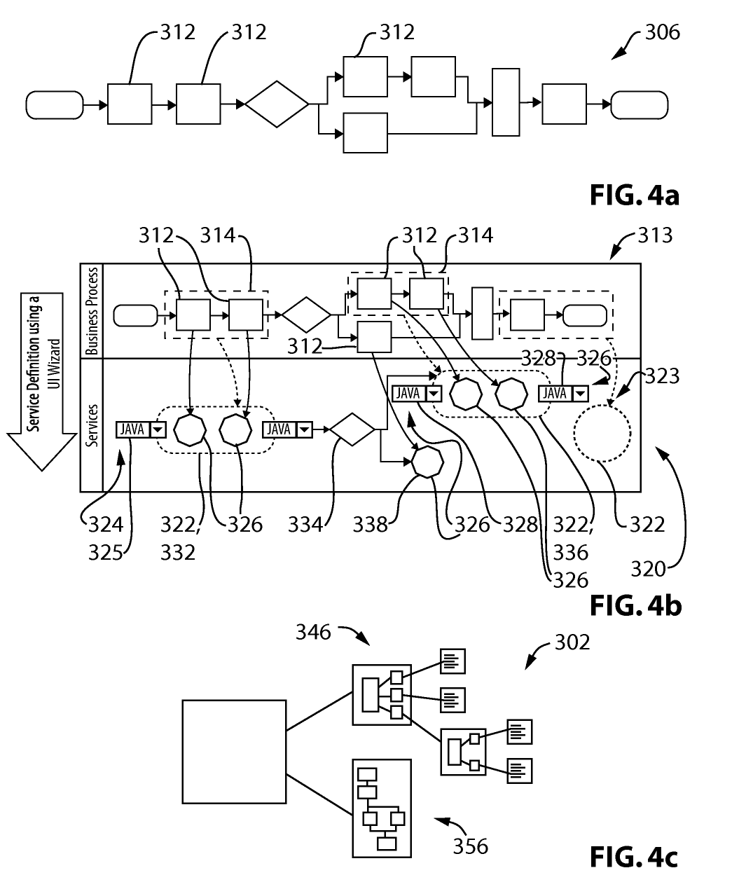

Reference is made to FIG. 3, which shows a flow diagram representing a method 300 of establishing a service oriented architecture-based business system 302 (FIG. 4c) incorporating service-oriented architecture based on a business process. The term ‘service oriented architecture’ may be referred to as SOA in the present disclosure.

The method 300 includes providing a business process model at step 304. An exemplary business process model is shown in FIG. 4a at 306. The business process model 306 may be developed using any suitable means, such as by IBM's WebSphere Business Modeler™, or by some other suitable business process modeling package. The business process model 306 may be developed by a first user 308 (FIG. 3), who may be, for example, a business analyst, whose expertise is in the business process, as opposed to a software architect (shown at 310), whose expertise is in software.

The business process model 306 (FIG. 4a) is made up of atomic business process steps 312, which represent steps in the business process that are irreducible into sets of smaller steps or that are not required to be reduced into smaller steps for the user's purposes.

Using a user interface wizard in a service modeling system 313, the user 308 (FIG. 3) defines one or more process step groupings 314 (FIG. 4b) of atomic business process steps 312. The user-defined process step groupings 314 represent groupings of process steps 312 that are directed to a common activity that the user 308 wants exposed as a service in the SOA-based business system 302.

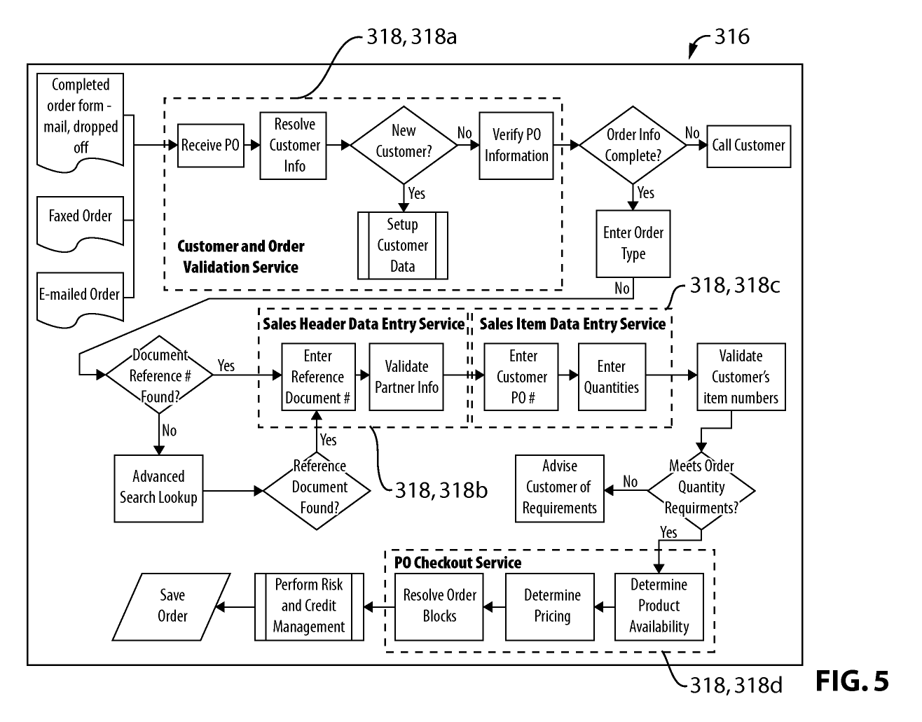

An example of such groupings is provided in FIG. 5, which shows an exemplary business process model 316 for a purchase order processing process. In the business process model 316, user defined groupings are shown at 318 generally, and include a Customer And Order Validation grouping, shown at 318a, a Sales Header Data Entry grouping, shown at 318b, a Sales Item Data Entry grouping, shown at 318c, and a Purchase Order Checkout grouping, shown at 318d.

Referring to FIG. 4b, the user 308 moves the groupings 314 into a service model layout area 320 of the service modeling system 313 to become service modules shown at 322, as part of the development of a service model 323. Service modules 322 provide relatively complex services. In the service model layout area 320, the service modules 322 are further defined by the user 308 (FIG. 3). For example, the user 308 (FIG. 3) can specify how the service module 322 is to be implemented. For example, the service module 322 may be implemented in Java™. A pull-down menu 324 or some other suitable means may be provided with each service module 322, which permits the user to select an implementation type, shown at 325, for the service module 322. The service module 322 may also be referred to simply as the module 322.

Some of the atomic business process steps 312 that make up the groupings 314 may themselves be moved into the service model layout area 320 as service components 326 (which may also be referred to as components 326). These components 326 provide simple (ie. relatively low level) services.

The components 326 and the modules 322 may be defined at a level of abstraction that is consistent with the open standard of SCA (service component architecture).

Similarly to the modules 322, each of these components 326 may also have an implementation type, shown at 328, associated therewith. It is optionally possible for each of the components 326 to automatically have an implementation type 328 that is the same as the implementation type 325 for the module 322 to which the components 326 belongs. Alternatively, the implementation type 328 for each of the components 326 may be user-selectable.

As shown in FIG. 4b, it is possible for the user 308 (FIG. 3) to move atomic business process steps 312 to the service model layout area 320 as components 326 that are not part of a module 322. It will be apparent that such components 326 would each have a user-selectable implementation type 328 associated therewith.

In addition to selecting the atomic business process steps 312 and groupings 314 of atomic business process steps 312 that are to be exposed as service components 326 or service modules 322, the user 308 (FIG. 3) may selecting the program flow that takes place between the selected service elements (ie. the components 326 and the modules 322), including any decisions that are required to be made. For example, in the service model 323 shown in FIG. 4b, the program flow from the module shown at 332 leads to a decision box 334. Based on the outcome of the decision box 334, the program flow leads either to a module shown at 336 or to a component shown at 338.

The process of completing the service model 323, including selecting groupings 314, defining modules 322 and components 322, and selecting program flow is encompassed in a step 339 shown in FIG. 3.

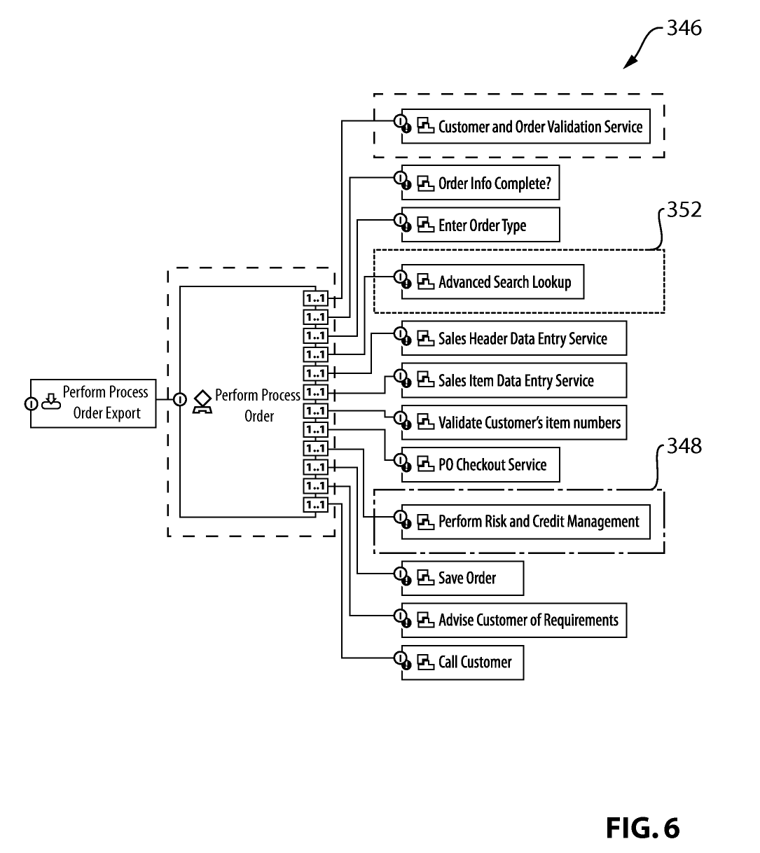

Once the user 308 has completed the service model 323, the service model 323 serves as input to an SOA transformation system 340 in FIG. 3. The SOA code development system 340 receives the service model 323 and transforms the service model 323 into code for the SOA-based business system 302. The SOA code development system 340 includes two elements, which are an artifact mapper 342 and a service assembler 344. The function of the artifact mapper 342 takes place at step 345. The artifact mapper 342 provides an assembly view of the service model 323, an example of which is shown at 346 in FIG. 6. In particular, the assembly view 346 shown in FIG. 6 relates to the business process model 316 shown in FIG. 5.

In the assembly view 346, the modules 322 and components 326 that make up the service model 323 are shown, and the user 308 can obtain information on whatever properties are associated with the components 326 and modules 322, such as the implementation types selected for them. In this view 346, the flow between the components 326 and modules 322 is not shown. It is optionally possible for the user 308 when viewing the assembly view 346 and to double-click on any module 322 and to see the components 326 that make up that module 322.

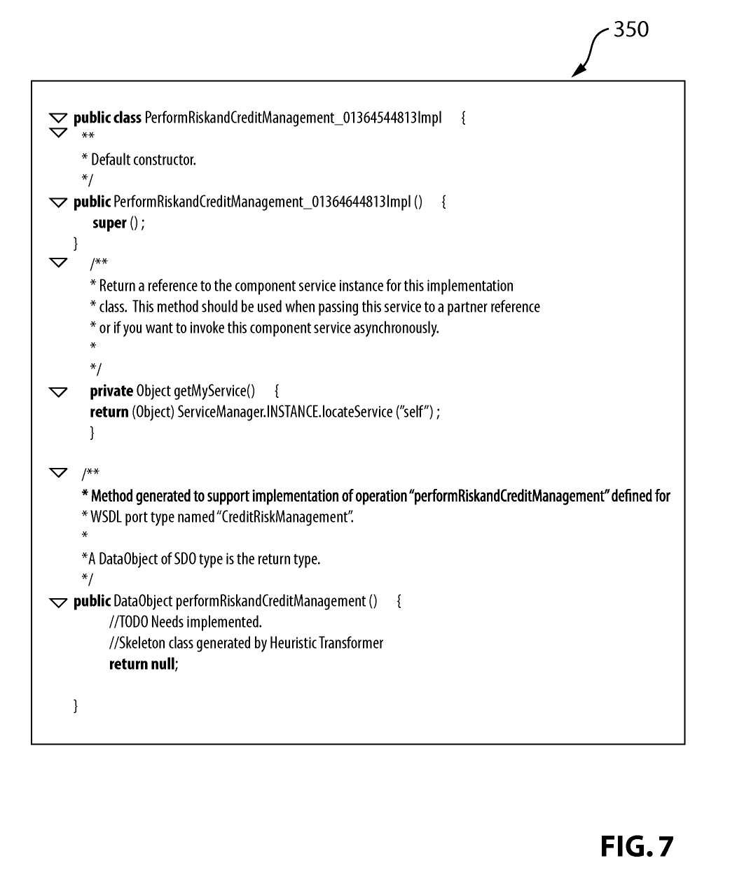

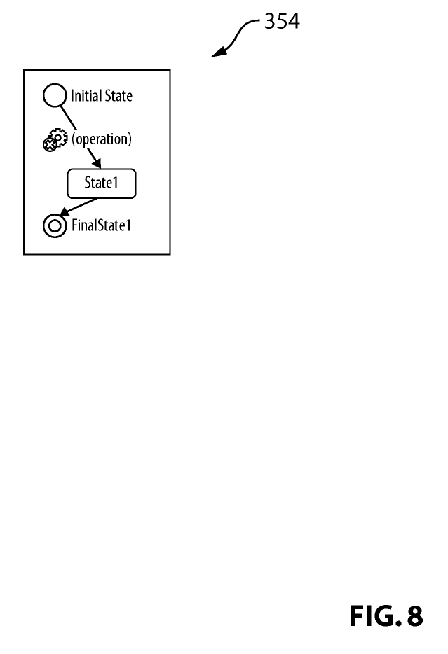

Referring to FIG. 3, the artifact mapper 342 prepares skeleton code for each of the components 326 (FIG. 4b) and modules 322 exposed as services by the user 308 (FIG. 3), in the format specified by the implementation type selected by the user 308. For example, as shown in FIG. 6, the implementation type associated with the module shown at 348, relating to performing a risk and credit analysis on a customer, is a Java implementation. The artifact mapper 342 may prepare skeleton code for a Java class, as shown at 350 in FIG. 7. As another example, for the component shown at 352 in FIG. 6, the artifact mapper 342 may prepare skeleton code for a state machine, as shown at 354 in FIG. 8, in accordance with the user.

For greater clarity, there may be any suitable number of services exposed and represented in the service model 323. For example, there may be two or more services exposed and represented in the service model 323.

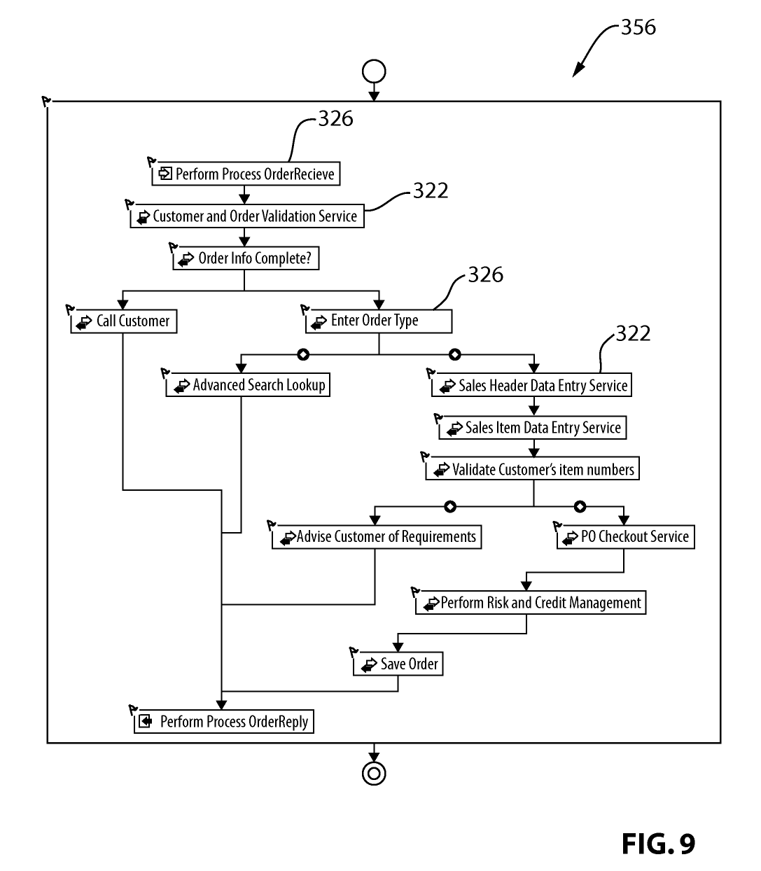

Referring to FIG. 3, the function of the service assembler 344 takes place at step 355 of the method 300. Referring to FIG. 9, the service assembler 344 (FIG. 3) provides an illustration of the program flow 356 for the service model 323 using BPEL (Business Process Editing Language), for the user 308 to review. The service assembler 344 establishes how the components 326 and modules 322 interoperate with each other. For example, for each component 326 or module 322, the service assembler 344 may add whatever references are necessary to other components 326 or modules 322 based on the program flow specified by the user 308 (FIG. 3).

Additionally, the service assembler 344 defines what data is transmitted and what the properties are for any transmitted data to and from each of the components 326 and modules 322, so that there is compatibility between transmitted data and requirements for input data when components 326 or modules 322 consume services provided by other components 326 of modules 322.

It will be understood that the assembly of modules 322 and components 326 that cooperate together in the SOA-based business system 302 is relatively loose, in the sense that the modules 322 and components 326 pass data and program flow to one another, however they all operate relatively independently from one another. They may all operate in different software languages, in different computers, using different operating systems. In accordance with the general concept of service-oriented architecture, any of these modules 322 and components 326 could, for example, be revised without any impact on any of the other modules 322 and components 326.

The assembly of modules 322 themselves, ie. the assembly of components 326 that operate together within a module 322, may be different to some extent than assembly of modules 322 and components 326 in the larger SOA-based business system 302. Assembly of components 326 within a module 322 may be relatively tighter. For example, the components 326 may operate using data directly from variables that belong to the module to which the components 326 belong. As another example, the components 326 may all be required to operate on the same hardware and be written in the same software language. As a further example, components 326 within a module 322 are not themselves accessible from outside the module 322; only the module 322 itself is accessible.

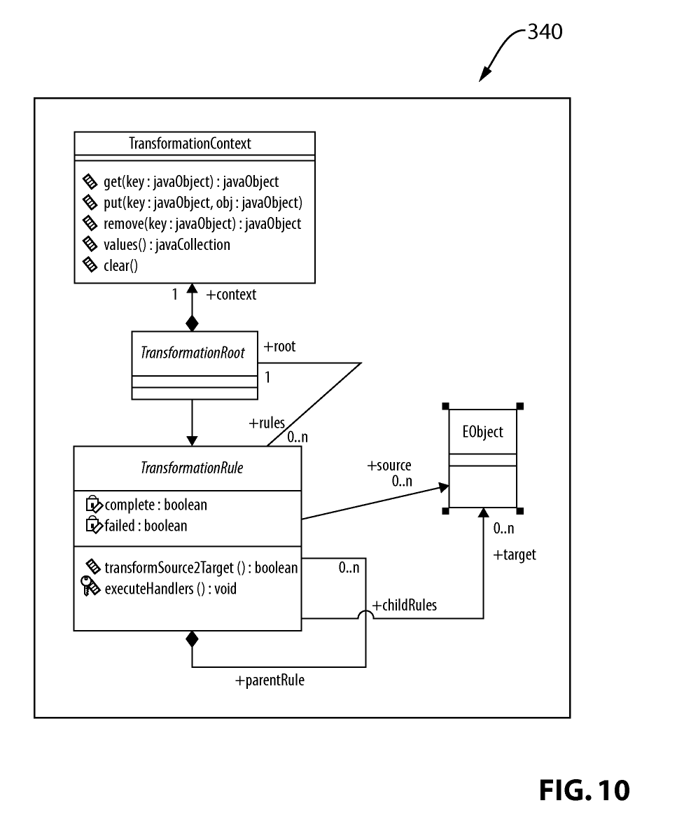

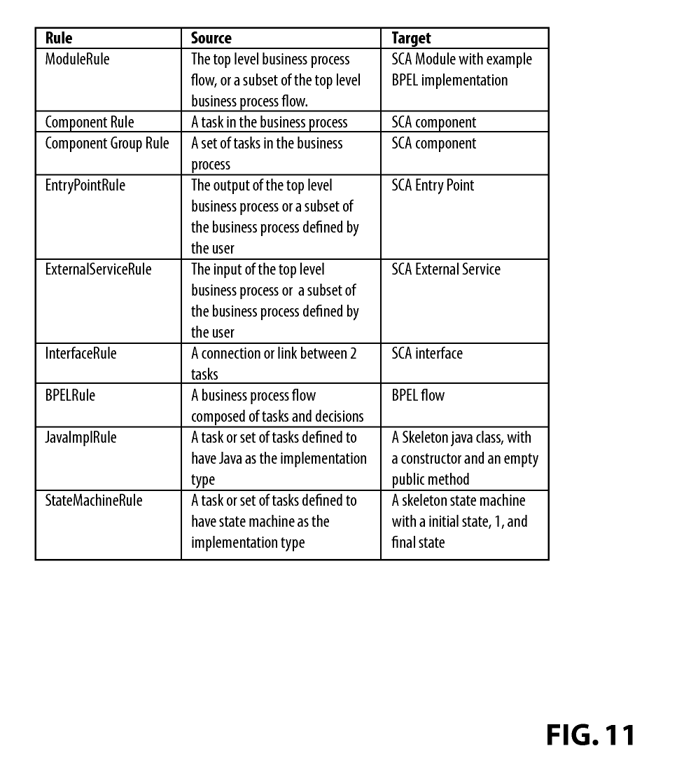

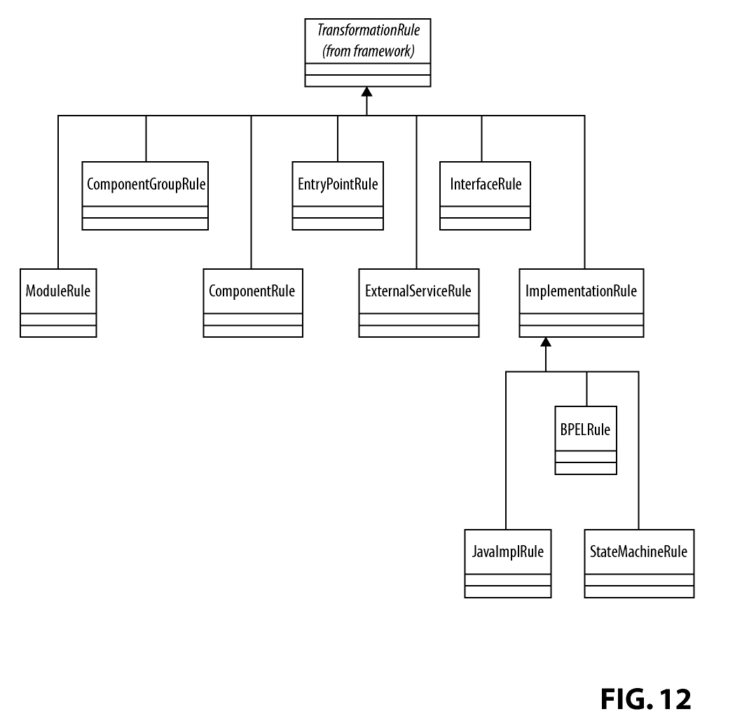

FIG. 10 illustrates the operation of the SOA code development system 340 when developing the skeleton code and adding elements to the skeleton code. The SOA code development system 340 applies transformation rules, which govern how the SOA code development system 340 generates code for each component 326 (FIG. 4b) or module 322. Examples of the source and target of each rule are shown in FIG. 11. FIG. 12 shows a hierarchy view of the exemplary rules identified in FIG. 11.

Referring to FIG. 3, after the SOA code development system 340 completes its development of the service-oriented components 326 and modules 322, any additional implementation details or coding that is required to complete the SOA-based business system 302 (FIG. 4c) can be provided by a suitable user, such as the software architect 310 (FIG. 3).

As a result of the service modeling system 313, the service model 323 is development easily by a person who is savvy with respect to the business process, but who may not be savvy with respect to software or coding. By contrast, in some businesses the service model 323 is developed by collaborative effort between both the business savvy user and the software architect. Thus, use of the service modeling system 313 reduces the need for the software architect to have direct involvement in the step of developing the service model 323.

Furthermore, as a result of the SOA code development system 340, the software architect 310 is made even more productive, since he or she is only required to complete code that is at least to some extent prepared by the system 340.

Additionally, the code that is written by the SOA code development system 340 is prepared at least to some extent based on the preferences inputted by the business analyst 304, instead of being based on fixed, inflexible rules.

The components 326 and the modules 322 may be stored in a suitable location by the SOA code development system 340 and may automatically be entered on an SOA registry for the business entity along with any relevant data with respect thereto, such as the entry points for the module 322, which define the public services provided by the module 322. After whatever further coding is required by the software architect 310, these elements, ie. the components 326 and modules 322, may then be resaved in a suitable storage location.

Alternatively, the step of entering the components 326 and the modules 322 on the SOA registry may be carried out manually by the software architect 310 after he or she has completed whatever further coding is required on the components 326 and modules 322.

In embodiments wherein one or more steps of the methods described herein are carried out using software, the coding of the software is within the skill of a person skilled in the art, after having read the description contained herein.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I/we claim:

1. A method for establishing an SOA-based business system incorporating service-oriented components based on a business process, the method comprising:
providing a business process model that relates to the business process;
selecting a first set of at least one element from the business process model for exposure as a first service;
selecting a second set of at least one element from the business process model for exposure as a second service;
generating, using automated means, at least skeleton code towards performing the first and second services; and
generating code using automated means to establish an interface between the first and second services.

2. A method for establishing an SOA-based business system as claimed in claim 1, further comprising:
selecting a program flow between the first and second services; and
generating code using automated means to establish the selected program flow between the first and second services.

3. A method for establishing an SOA-based business system as claimed in claim 1, further comprising:
selecting a software language each of the first and second services is to be implemented, wherein the at least skeleton code is generated in the selected software language.

4. A method for establishing an SOA-based business system as claimed in claim 1, further comprising generating code at least partially manually towards performing the first and second services.

5. A method for establishing an SOA-based business system incorporating service-oriented components based on a business process, the method comprising:
providing a business process model that relates to the business process;
providing a graphical user interface configured to display the business process model and configured to provide a graphical control for the user to group together elements from the business process model;
grouping together elements from the business process model for exposure as a service, using the graphical user interface; and
generating, using automated means, at least skeleton code towards performing the service.

6. A method for establishing an SOA-based business system as claimed in claim 5, the service is a first service and wherein the method further comprises:
grouping together elements from the business process model for exposure as a second service, using the graphical user interface; and
generating code using automated means to establish an interface between the first and second services.

7. A method for establishing an SOA-based business system as claimed in claim 5, wherein the service is a first service and wherein the method further comprises:
grouping together elements from the business process model for exposure as a second service, using the graphical user interface;
selecting a program flow between the first and second services using the graphical user interface; and
generating code using automated means to establish the selected program flow between the first and second services.

8. A method for establishing an SOA-based business system as claimed in claim 5, further comprising:
selecting, using the graphical user interface, a software language in which the service is to be implemented, wherein the at least skeleton code is generated in the selected software language.

9. A data processing system for establishing an SOA-based business system incorporating service-oriented components based on a business process model and based on a first set of business process model elements and a second set of business process model elements selected for exposure as first and second services respectively, the data processing system comprising:
at least one processor;
a bus coupled to the at least one processor;
at least one computer usable medium coupled to the bus, wherein the at least one computer usable medium contains a set of instructions and wherein the at least one processor is adapted to carry out the set of instructions by causing the data processing system to:
generate at least skeleton code towards performing the first and second services; and
generate code to establish an interface between the first and second services.

10. A data processing system as claimed in claim 9, wherein the at least one processor is further adapted to carry out the set of instructions by causing the data processing system to:
receive input from a user regarding selection of a program flow between the first and second services; and
generate code to establish the selected program flow between the first and second services.

11. A data processing system as claimed in claim 9, wherein the at least one processor is further adapted to carry out the set of instructions by causing the data processing system to:
receive input from a user regarding the selection of a software language in which each of the first and second services is to be implemented, wherein the at least skeleton code is generated in the selected software language.

12. A data processing system for establishing an SOA-based business system incorporating service-oriented components based on a business process, the data processing system comprising:
at least one processor;
a bus coupled to the at least one processor;
at least one computer usable medium coupled to the bus, wherein the at least one computer usable medium contains a set of instructions and wherein the at least one processor is adapted to carry out the set of instructions by causing the data processing system to:
provide a business process model that relates to the business process;
provide a graphical user interface configured to display the business process model and configured to provide a graphical control for the user to group together elements from the business process model;
receive input from a user relating to grouping together elements from the business process model for exposure as a service, using the graphical user interface; and
generate at least skeleton code towards performing the service.

13. A data processing system as claimed in claim 12, wherein the service is a first service and wherein the at least one processor is further adapted to carry out the set of instructions by causing the data processing system to:
receive input from a user regarding grouping together elements from the business process model for exposure as a second service, using the graphical user interface; and
generate code to establish an interface between the first and second services.

14. A data processing system as claimed in claim 12, wherein the service is a first service and wherein the at least one processor is further adapted to carry out the set of instructions by causing the data processing system to:
receive input from a user regarding grouping together elements from the business process model for exposure as a second service, using the graphical user interface;
receive input from a user regarding selection of a program flow between the first and second services using the graphical user interface; and
generate code to establish the selected program flow between the first and second services.

15. A data processing system as claimed in claim 12, wherein the at least one processor is further adapted to carry out the set of instructions by causing the data processing system to receive input from a user using the graphical user interface regarding selection of a software language in which the service is to be implemented, wherein the at least skeleton code is generated in the selected software language.

16. A computer program product comprising at least one computer usable medium including computer-usable program code for establishing an SOA-based business system incorporating service-oriented components based on a business process model and based on a first set of business process model elements and a second set of business process model elements selected for exposure as first and second services respectively, the computer program product further comprising:
computer-usable program code for generating at least skeleton code towards performing the first and second services; and
computer-usable program code for generating code to establish an interface between the first and second services.

17. A computer program product as claimed in claim 16, further comprising:
computer-usable program code for receiving input from a user regarding selection of a program flow between the first and second services; and
computer-usable program code for generating code to establish the selected program flow between the first and second services.

18. A computer program product as claimed in claim 16, further comprising:
computer-usable program code for receiving input from a user regarding the selection of a software language in which each of the first and second services is to be implemented, wherein the at least skeleton code is generated in the selected software language.

19. A computer program product comprising at least one computer usable medium including computer-usable program code for establishing an SOA-based business system incorporating service-oriented components based on a business process, the computer program product further comprising:
computer-usable program code for providing a business process model that relates to the business process;
computer-usable program code for providing a graphical user interface configured to display the business process model and configured to provide a graphical control for the user to group together elements from the business process model;
computer-usable program code for receiving input from a user relating to grouping together elements from the business process model for exposure as a service, using the graphical user interface; and
computer-usable program code for generating at least skeleton code towards performing the service.

20. A computer program product as claimed in claim 19, wherein the service is a first service and wherein and wherein the computer program product further comprises:
computer-usable program code for receiving input from a user regarding grouping together elements from the business process model for exposure as a second service, using the graphical user interface; and
computer-usable program code for generating code to establish an interface between the first and second services.

21. A computer program product as claimed in claim 19, wherein the service is a first service and wherein and wherein the computer program product further comprises:
computer-usable program code for receiving input from a user regarding grouping together elements from the business process model for exposure as a second service, using the graphical user interface;
computer-usable program code for receiving input from a user regarding selection of a program flow between the first and second services using the graphical user interface; and
computer-usable program code for generating code to establish the selected program flow between the first and second services.

22. A computer program product as claimed in claim 19, further comprising:
computer-usable program code for receiving input from a user using the graphical user interface regarding selection of a software language in which the service is to be implemented, wherein the at least skeleton code is generated in the selected software language.
